(19) United States
(12) Patent Application Publication
(10) Pub. No.: US 2015/0161270 A1
(43) Pub. Date: Jun. 11, 2015

(54) COMPUTER ECOSYSTEM IDENTIFYING SURPRISING BUT RELEVANT CONTENT USING ABSTRACT VISUALIZATION OF USER PROFILES

(71) Applicant: SONY CORPORATION, TOKYO (JP)

(72) Inventor: Graham Clift, Poway, CA (US)

(73) Assignee: SONY CORPORATION, TOKYO (JP)

(21) Appl. No.: 14/097,805

(22) Filed: Dec. 5, 2013

(51) Int. Cl. G06F 17/30

(52) U.S. Cl. CPC G06F 17/30867; G06F 17/30598

(57) ABSTRACT

Pixel abstractions are generated from elements of a user's profile and used to populate an image template, which is compared against the templates of other users to find otherwise surprising similarities. When a match is found, favorite content associated with the user of the matching template can be recommended to the user of the matched template, and user feedback regarding the worth of the recommendation received to adjust the abstraction process.

### I. FIELD OF THE INVENTION

The present application relates generally to computer ecosystems and more particularly to finding surprising but relevant content using abstract visualization of user profiles.

### II. BACKGROUND OF THE INVENTION

A computer ecosystem, or digital ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the Internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from consumers and manufactures, increasing the capacity for novel innovations and adaptations to changing demands.

Present principles are directed to specific aspects of computer ecosystems, specifically, to finding content to recommend to one user based on the content enjoyed by other users. Current audio and video content suggestion engines often rely on overlapping areas of interest between similarly profiled users to create recommendations of suitable new content for viewing. Some engines may be capable of taking a group of user profiles and creating new recommendations too. The challenge is to actually create recommendations that are novel and surprising but still likely enjoyable by the user or group of users.

### SUMMARY OF THE INVENTION

Present principles supplement recommendation engines by only searching for surprising yet relevant content. Abstract visual representations are created of a user's profile, and then a pattern recognition engine, preferably with nonlinear feedback, processes the abstract visual representation of the profile to identify new emergent correlations between users that typically would be overlooked in traditional profile comparisons. Looking at the commonly enjoyed content revealed by the close pattern matches but that lies outside of the target user or users normal preference fields becomes the source for the suggestion. The pattern matching algorithms may evolve continuously based on feedback indicating their success rates in recommending good (relevant) new content such that, like finding the eyes in a facial recognition of a photo, the pattern matcher can locate and weight sweet spots or dead spots according to sensitivity revealed in the user feedback to the recommendation.

The user profile may consist of both static and dynamic information like watching/listening history, preferred genres, age, sex, marital status, time of day, mood, work schedule, location and so on. An abstract pixel image can be constructed with this information using various algorithms that allocate regions of the image to this information, blending where the information overlaps and constructing harder edges where it is more distinct. Pixel density may be used for the more static information like age and sex, and color may be used for dynamic information time of day and mood. Once constructed, the abstract image can be continuously updated and a snapshot of the image stored by the suggestion engine every time the user provides user feedback as to the worth of content recommendations flowing from the engine.

The engine looks at the image and compares it to its growing database of images from other users using pattern recognition algorithms that can be refined over time. The engine can search for content common in the matches it finds but that is not present in the users profile and this becomes the suggestion. This can be extended to multiple users by blending abstract images of all the target users and then looking for pattern matches and the content they have in common against content that is rare in the group. The feedback can account for the group's opinion of the suggestion rather than that of an individual user.

Accordingly, a device includes at least one computer readable storage medium bearing instructions executable by a processor, and at least one processor configured for accessing the computer readable storage medium to execute the instructions to configure the processor for receiving at least a first demographic datum from a user profile associated with a first user. The instructions also configure the processor for establishing an abstract pixel representation of the first datum in a first region of an image template, comparing the image template to at least a template of a second user, and based at least in part on the comparing, determining whether to recommend content associated with the second user to the first user.

In some embodiments the processor when executing the instructions is further configured for receiving at least a second demographic datum from a user profile associated with a first user and establishing an abstract pixel representation of the second datum in a second region of the image template. The image template is compared to at least a template of the second user, and based at least in part on the comparing, it is determined whether to recommend content associated with the second user to the first user.

The first datum can be unchanging, e.g., user sex or user race, and the second datum can changes over time, e.g., user age, user location, user mood, favorite content of the first user.

If desired, the processor when executing the instructions can be further configured for blending at least a first border segment between the first and second regions at least in part by averaging first pixels in the first region with second pixels in the second region responsive to a first determination of similarity between the first and second regions. The processor when executing the instructions can be further configured for not blending at least a first border segment between the first and second regions at least in part by averaging first pixels in the first region with second pixels in the second region responsive to a second determination of similarity between the first and second regions.

In another aspect, a method includes accessing a profile of a first user. The profile includes a first datum and a second datum, and the method also includes generating respective first and second abstract pixel groups representing the first and second data. A first region of an image template is allocated to the abstract pixel group of the first datum while a second region of the image template is allocated to the abstract pixel group of the second datum. The method also includes comparing the image template to plural images representing at least portions of respective profiles of respective other users, and responsive to the comparing, determining that the image template matches at least one matching image of at least one other user. At least one content associated with the other user is recommended to the first user.

In another aspect, a system includes at least one computer readable storage medium bearing instructions executable by a processor which is configured for accessing the computer readable storage medium to execute the instructions to configure the processor for generating an abstraction of information in a profile of a first use. The processor when executing the instructions is configured for comparing the abstraction to information derived from other users, and responsive to the comparing, determining whether to recommend to the first user at least one content associated with another user.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a flowchart of example overall logic

FIG. 3 is a schematic representation of example abstraction of user data; and

FIG. 4 is an example a user interface for inputting and receiving user feedback of the effectiveness of the recommendation,

### DETAILED DESCRIPTION OF THE PREFERRED EMBODIMENT

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

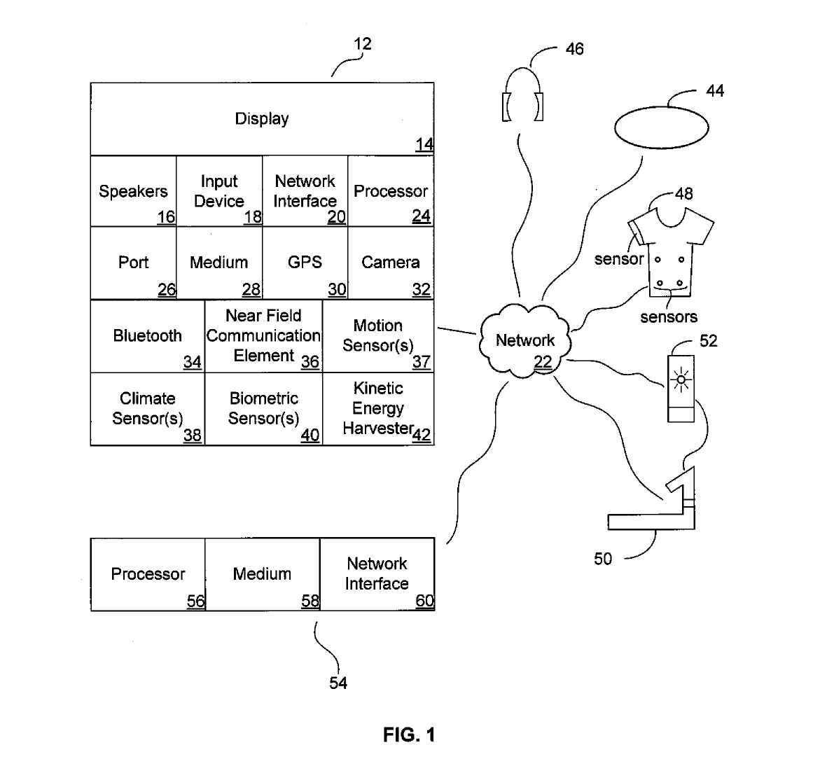

Now specifically referring to FIG. 1, an example system 10 is shown, which may include one or more of the example devices mentioned above and described further below in accordance with present principles. The first of the example devices included in the system 10 is an example consumer electronics (CE) device 12 that may be waterproof (e.g., for use while swimming). The CE device 12 may be, e.g., a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc., and even e.g. a computerized Internet-enabled television (TV). Regardless, it is to be understood that the CE device 12 is configured to undertake present principles (e.g. communicate with other CE devices to undertake present principles, execute the logic described herein, and perform any other functions and/or operations described herein).

Accordingly, to undertake such principles the CE device 12 can be established by some or all of the components shown in FIG. 1. For example, the CE device 12 can include one or more touch-enabled displays 14, one or more speakers 16 for outputting audio in accordance with present principles, and at least one additional input device 18 such as e.g. an audio receiver/microphone for e.g. entering audible commands to the CE device 12 to control the CE device 12. The example CE device 12 may also include one or more network interfaces 20 for communication over at least one network 22 such as the Internet, an WAN, an LAN, etc. under control of one or more processors 24. It is to be understood that the processor 24 controls the CE device 12 to undertake present principles, including the other elements of the CE device 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, WiFi transceiver, etc.

In addition to the foregoing, the CE device 12 may also include one or more input ports 26 such as, e.g., a USB port to physically connect (e.g. using a wired connection) to another CE device and/or a headphone port to connect headphones to the CE device 12 for presentation of audio from the CE device 12 to a user through the headphones. The CE device 12 may further include one or more tangible computer readable storage medium 28 such as disk-based or solid state storage, it being understood that the computer readable storage medium 28 may not be a carrier wave. Also in some embodiments, the CE device 12 can include a position or location receiver such as but not limited to a GPS receiver and/or altimeter 30 that is configured to e.g. receive geographic position information from at least one satellite and provide the information to the processor 24 and/or determine an altitude at which the CE device 12 is disposed in conjunction with the processor 24. However, it is to be understood that that another suitable position receiver other than a GPS receiver and/or altimeter may be used in accordance with present principles to e.g. determine the location of the CE device 12 in e.g. all three dimensions.

Continuing the description of the CE device 12, in some embodiments the CE device 12 may include one or more cameras 32 that may be, e.g., a thermal imaging camera, a digital camera such as a webcam, and/or a camera integrated into the CE device 12 and controllable by the processor 24 to gather pictures/images and/or video in accordance with present principles. Also included on the CE device 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the CE device 12 may include one or more motion sensors 37 (e.g., an accelerometer, gyroscope, cyclometer, magnetic sensor, infrared (IR) motion sensors such as passive IR sensors, an optical sensor, a speed and/or cadence sensor, a gesture sensor (e.g. for sensing gesture command), etc.) providing input to the processor 24. The CE device 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. In addition to the foregoing, it is noted that in some embodiments the CE device 12 may also include a kinetic energy harvester 42 to e.g. charge a battery (not shown) powering the CE device 12.

Still referring to FIG. 1, in addition to the CE device 12, the system 10 may include one or more other CE device types such as, but not limited to, a computerized Internet-enabled bracelet 44, computerized Internet-enabled headphones and/or ear buds 46, computerized Internet-enabled clothing 48, a computerized Internet-enabled exercise machine 50 (e.g. a treadmill, exercise bike, elliptical machine, etc.), etc. Also shown is a computerized Internet-enabled entry kiosk 52 permitting authorized entry to a space. It is to be understood that other CE devices included in the system 10 including those described in this paragraph may respectively include some or all of the various components described above in reference to the CE device 12 such but not limited to e.g. the biometric sensors and motion sensors described above, as well as the position receivers, cameras, input devices, and speakers also described above.

Now in reference to the afore-mentioned at least one server 54, it includes at least one processor 56, at least one tangible computer readable storage medium 58 that may not be a carrier wave such as disk-based or solid state storage, and at least one network interface 60 that, under control of the processor 56, allows for communication with the other CE devices of FIG. 1 over the network 22, and indeed may facilitate communication between servers and client devices in accordance with present principles. Note that the network interface 60 may be, e.g., a wired or wireless modem or router, WiFi transceiver, or other appropriate interface such as, e.g., a wireless telephony transceiver.

Accordingly, in some embodiments the server 54 may be an Internet server, may include and perform “cloud” functions such that the CE devices of the system 10 may access a “cloud” environment via the server 54 in example embodiments.

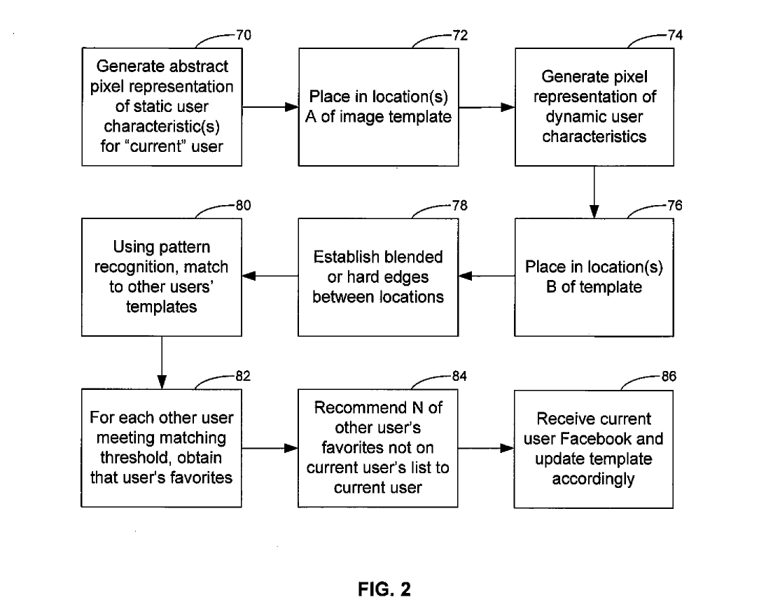

Now referring to FIG. 2, which shows logic that may be implemented by any of the processors above alone or in combination, at block 70 a user profile is accessed and abstract representations of one or more static or immutable parameters thereof is generated. In one example the abstract representation may be an abstract pixel representation. Other patterns apart from pixels may be used, e.g., abstract sonic digital tracks may be used. In any case, the user profile information may be accessed as input by a user of the CE device 12 using an input device thereof, and the logic when executed by the CE device processor may simply access the stored user-input profile information. Or, if the logic is implemented by a cloud server, the profile information may be sent from the CE device 12 to the cloud server over a network. The profile information may also or alternately be accessed from social network site accounts of the user by requesting login information from the user or otherwise obtaining access to the accounts. The profile information also may be built over time by servers communicating with the CE device of the user and recording various user interactions and inputs, providing those to the processor executing the instructions as profile information. The profile information may include immutable characteristics of the user such as race and sex and changing characteristics such as age, location, mood, favorite content, income, education, physical traits, employment, etc. Mood for example may be input directly by a user or may be inferred from biometric sensors such as any of those described above and coupled to the user. For example, a mood of “relaxed” may be inferred from low pulse rate received by the processor from a pulse rate monitor, while “angry” or “excited” may be inferred from a high pulse rate.

The abstraction when using a pixel-based embodiment may be generated in a number of ways. In one example, the abstraction may use one pixel density for one type of profile parameter and a different pixel density for another type of parameter. For example, pixel representations of immutable parameters may be twice as dense (in, e.g., pixels per square centimeter) as pixel representations of changing parameters. Or, black and white coded pixels only may be used for one type of parameter, e.g., for immutable parameters, while color pixel values in addition to black and white only may be used for other parameters. A single parameter may have different density/color codes than others. Each parameter may have its own respective pixel density/color code to identify it.

Also, the pixel abstractions may be to use a pseudo-random locating of the pixels, e.g., using a pseudo-random generator the position of a first pixel to be used in the representation in a window size of N pixels by M pixels, where N and M are integers, may be determined. The position in the window of the next pixel may also be randomly determined. The window size may vary randomly or it may be fixed and this may depend on the particular profile parameter or profile parameter type being represented. Alternative to purely random pixel positions, the pixel positions in concert, while abstracting the underlying parameter, may bear a visible resemblance to the parameter. For example, the abstraction for the user's age parameter may include one of the two digits in the user's age, or it may be groups of pixels forming the two digits of the user's age but arranged such that the groups when viewed together establish a visual representation of the word “age”. The number of pixels used in the abstraction of any profile parameter may be fixed, may be random, and/or may be unique for each parameter or for each parameter type.

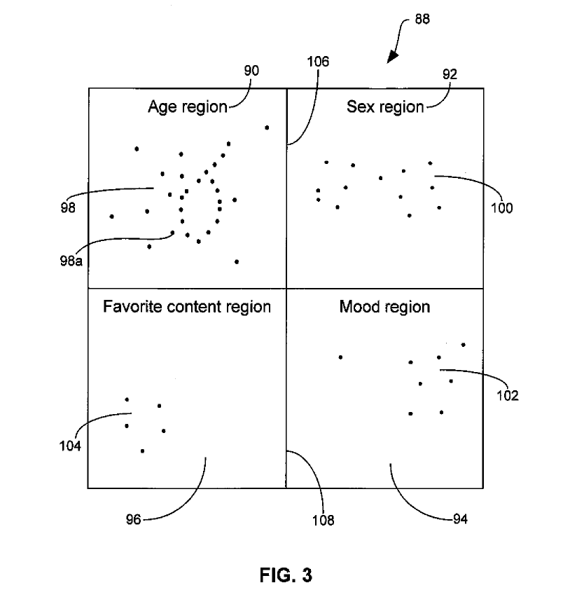

Once a pixel abstraction is generated for one or more static profile parameters, at block 72 the abstractions may be placed in respective regions of an image template, such as the example template shown in FIG. 3 and discussed further below. Blocks 74 and 76 indicate that the same process as described for generating abstractions and placing them in respective regions of the template is also followed for changing user parameters (also referred to herein as “characteristics”).

In some example embodiments, the logic may proceed to block 78 to establish either blended transitions between regions or “hard”, bright-line borders between regions. Typically, blending may be done between regions representing respective parameters that overlap while bright line borders may be established between regions representing respective parameters that do not overlap. As an example, age and sex may be regarded in some implementations as not overlapping, while an emotional mood may be considered to overlap with the sex of the user. Other overlapping characteristics or parameters may include age and favorite content genus, sex and favorite content genus, etc. Blending may be accomplished in some embodiments by averaging the pixel values in the N-closet pixel columns to the border between adjacent regions in one region with the mirror position pixel values of the opposite region, and then setting the values of all the border area pixels to be random variations of the average within a small range of the average value. Other blending techniques may be used, e.g., any of the techniques described in the present assignee's U.S. Pat. Nos. 8,406,548, 8,004,644, 6,727,905, and 6,646,640, incorporated herein by reference.

Once the image template has been established using the abstractions of one or more of the user profile parameters, at block 80 the image template is compared against abstraction templates of other users derived as disclosed above, and/or is compared against an average or composite user abstraction template derived from multiple users. The comparison may be done on a pixel by pixel basis, determining, for each pixel in the current user's template that is located at the same (or within a predetermined range of) the location of a pixel in the template to which it is being compared, the values of the two pixels are within a predetermined range of each other. Then, a “match” may be returned if, for example, M % of the pixel values are within the range. Or, a “match” may be returned only if a minimum absolute number of pixels from the template under test “match” corresponding pixels in the template being tested against. Yet again, the pixel values in the template being tested may be arranged from lowest to highest, the pixel values in the template being tested against likewise arranged from lowest to highest to establish pixel pairings, and only if a minimum number of pixel pairings or percentage of pixel pairings reveal pixel values within a range of values, a “match” is returned.

Yet again, existing pattern recognition/image recognition engines may be used which nonlinear feedback to determine whether the image being tested “matches”, within the particular engine's definition of “match”, the image being tested against. For example, pattern recognition principles divulged in Handbook of Pattern Recognition, Young, 1986, incorporated herein by reference, may be used, and/or engines and methods divulged in the present assignee's U.S. Pat. Nos. 8,411,906, 8,194,934, 7,340,079, incorporated herein by reference, may be used.

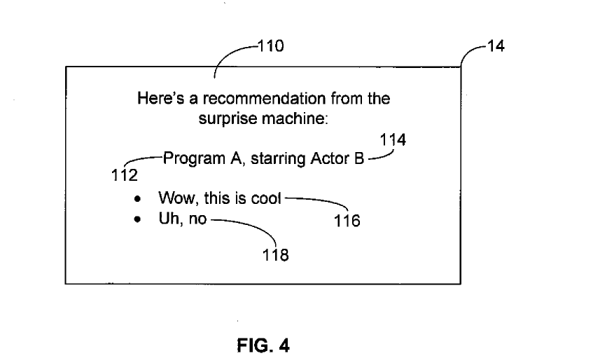

Proceeding to block 82, when a match is found between the current user's template being tested and a template being tested against, at least one content associated with the user of the template being tested against is obtained and at block 84 recommended to the user associated with the template being tested. For example, the “favorites” list of the user associated with the template being tested against may be accessed and the names of “N” of the contents in the list (N being an integer) returned to the user associated with the template being tested. FIG. 4 shows an example user interface (UI) that may be presented on the display of the CE device of the user associated with the template being tested as a means of returning recommendations from other users. At block 86, feedback from the user associated with the template being tested is received as to the user's evaluation of the recommendation (on a scale of one to ten, for instance, or simply a binary selection between “good” and “bad”). This feedback is used to alter (or not) the abstraction engine. For instance, a feedback rating of “9” (with 10 being the highest) may result in altering the abstract generation of only ten percent of the pixels next used to recalculate the pixel abstractions of the user's parameters, while a feedback rating of “1” may result in altering the abstract generation of ninety percent of the pixels next used to recalculate the pixel abstractions of the user's parameters, with ratings between “1” and “9” correspondingly causing the altering of varying percentages of pixel generations. The template is then recalculated beginning back at block 70 and the process repeated if desired. Other user-feedback learning algorithms may be used.

FIG. 3 is a schematic view of an example image template 88 which, for illustration, uses four parameter regions 90, 92, 94, 96 respectively representing abstractions for user parameters of age, sex, mood, and favorite content, respectively. Each region 90-96 includes respective pixel patterns 98, 100, 102, 104 that have been generated according to principles above. For illustration it has been assumed that the parameters sex and age overlap, so that a border region 106 between them is blended as described above, whereas it is assumed that the mood region and favorite content regions do not overlap, so that a bright line boundary 108 is drawn between them. The patterns shown in FIG. 3 are indeed abstract except for a sub-pattern 98a in the pattern 98 of the age region 90, which forms a visible numeral “6”, in this case, the last digit of the age of a 46 year old user.

FIG. 4 illustrates an example UI 110 that may be presented on the current user's CE device display 14 to return a recommended content title 112 along with the name 114 of an actor or actors in the content. The content title is from content associated with a user of a “matched” template according to principles above. Also, the user can give feedback, in the example shown, by selecting a like selector 116 or a dislike selector 118, which is used as described above to modify the abstracting step at block 70 and 72 of FIG. 2.

While the particular COMPUTER ECOSYSTEM IDENTIFYING SURPRISING BUT RELEVANT CONTENT USING ABSTRACT VISUALIZATION OF USER PROFILES is herein shown and described in detail, it is to be understood that the subject matter which is encompassed by the present invention is limited only by the claims.

What is claimed is:

1. A device comprising:
at least one computer readable storage medium bearing instructions executable by a processor;
at least one processor configured for accessing the computer readable storage medium to execute the instructions to configure the processor for:
receiving at least a first demographic datum from a user profile associated with a first user;
establishing an abstract pixel representation of the first datum in a first region of an image template;
comparing the image template to at least a template of a second user; and
based at least in part on the comparing, determining whether to recommend content associated with the second user to the first user.

2. The device of claim 1, wherein the processor when executing the instructions is further configured for:
receiving at least a second demographic datum from a user profile associated with a first user;
establishing an abstract pixel representation of the second datum in a second region of the image template;
comparing the image template to at least a template of the second user; and
based at least in part on the comparing, determining whether to recommend content associated with the second user to the first user.

3. The device of claim 2, wherein the first datum is unchanging and the second datum changes over time.

4. The device of claim 3, wherein the first datum includes at least one of: sex, race.

5. The device of claim 3, wherein the second datum includes at least one content identification associated with a favorite content of the first user.

6. The device of claim 2, wherein the processor when executing the instructions is further configured for:
blending at least a first border segment between the first and second regions at least in part by averaging first pixels in the first region with second pixels in the second region responsive to a first determination of similarity between the first and second regions.

7. The device of claim 2, wherein the processor when executing the instructions is further configured for:
not blending at least a first border segment between the first and second regions at least in part by averaging first pixels in the first region with second pixels in the second region responsive to a second determination of similarity between the first and second regions.

8. Method comprising:
accessing a profile of a first user, the profile including at least a first datum and a second datum;
generating respective first and second abstract pixel groups representing the first and second data;
allocating a first region of an image template to the abstract pixel group of the first datum;
allocating a second region of the image template to the abstract pixel group of the second datum;
comparing the image template to plural images representing at least portions of respective profiles of respective other users;
responsive to the comparing, determining that the image template matches at least one matching image of at least one other user; and
recommending to the first user at least one content associated with the at least one other user.

9. The method of claim 8, wherein the first datum is at least one of: sex, race, and the second datum is at least one of: user watching/listening history, user preferred genres, user age, user marital status, time of day, user mood, user work schedule, user location.

10. The method of claim 8, comprising using a first pixel density for the first pixel group and using a second pixel density for the second pixel group, the first pixel density being different from the second pixel density.

11. The method of claim 10, wherein the first pixel density is used based on what the first datum is.

12. The method of claim 8, comprising using color pixels for the abstract pixel group representing the first datum and using only black and white pixels for the abstract pixel group representing the second datum.

13. The method of claim 8, comprising executing the comparing at least in part using an image and/or pattern recognition engine.

14. The method of claim 8, comprising:
combining abstract pixel groups of plural users to render a consolidated pixel group; and
comparing the consolidated pixel group against individual user pixel groups to determine matches therebetween to account for a group's opinion of a content recommendation.

15. System comprising:
at least one computer readable storage medium bearing instructions executable by a processor which is configured for accessing the computer readable storage medium to execute the instructions to configure the processor for:
generating an abstraction of information in a profile of a first user;
comparing the abstraction to information derived from other users; and
responsive to the comparing, determining whether to recommend to the first user at least one content associated with another user.

16. The system of claim 15, wherein the information derived from other users are also abstractions.

17. The system of claim 15, wherein the generating includes:
receiving at least a first demographic datum from the profile associated with the first user; and
establishing an abstract pixel representation of the first datum in a first region of an image template.

18. The system of claim 17, wherein the processor when executing the instructions is further configured for:
receiving at least a second demographic datum from the profile associated with the first user; and
establishing an abstract pixel representation of the second datum in a second region of the image template.

19. The system of claim 18, wherein the first datum is unchanging and the second datum changes over time.

20. The system of claim 18, wherein the processor when executing the instructions is further configured for:
blending at least a first border segment between the first and second regions at least in part by averaging first pixels in the first region with second pixels in the second region responsive to a first determination of similarity between the first and second regions.
